(19) United States
(12) Patent Application Publication
(10) Pub. No.: US 2010/0063610 A1
(43) Pub. Date: Mar. 11, 2010

(54) METHOD OF PROCESS MODULES PERFORMANCE MATCHING

(76) Inventors: David Angell, Poughkeepsie, NY (US); Bruce Raymond Clemens, Essex Junction, VT (US); Michael W. Mock, Essex Junction, VT (US); Gary R. Moore, Milton, VT (US); Kathy Shackett, Shelburne, VT (US); Nancy Tovey, South Burlington, VT (US); Justin Wai-chow Wong, South Burlington, VT (US)

Correspondence Address: SCULLY, SCOTT, MURPHY & PRESSER, P.C., 400 GARDEN CITY PLAZA, Suite 300, GARDEN CITY, NY, 11530, US

(21) Appl. No.: 12/206,220

(22) Filed: Sep. 8, 2008

(51) Int. Cl. G06F 19/00; G06F 15/00

(52) U.S. Cl. 700/108; 702/183

(57) ABSTRACT

A method and system employing said method for analyzing process module performance in semiconductor manufacturing. The method and system include process modules as part of a process tool. A process initiated in the process module includes steps. Each step includes specified performance parameters. A detection device detects at least one predetermined measurement in the process module. A program and processor generate data about the process module and steps and generates data about the steps and the process module. The program provides statistical analysis of the steps and the environment of the process module using the generated data and the performance parameters. The program determines variations between the process step performance parameters and the generated data about the process steps.

### FIELD OF THE INVENTION

The present invention relates to a method, and a system employing the method, for analyzing process module performance in semiconductor manufacturing, and more specifically, for analyzing process module performance using data collection and data analysis during semiconductor manufacturing.

### BACKGROUND OF THE INVENTION

Current microelectronics and submicron manufacturing includes semiconductor processing which may have multiple tools and processing chambers or process modules employed to produce high volume parts. As a result of greater manufacturing productivity requirements, tools and/or process module performance varying or shifting from base line performance may result in yield or reliability degradation. Current manufacturing processes are lacking the ability to diagnose undesirable process variations from specifications (i.e., base line parameters). Further, current manufacturing processes are lacking in the ability to compare and detect differences between like process tools. Additionally, there is a need in the industry to provide diagnostics which determine one or more causes of the undesirable variations. Further, there is also a need for improving data collection during a process to facilitate determining appropriate action during the process, which may include corrective action or termination of the process.

It would therefore be desirable to provide a method, and system employing the same, for capturing data for diagnosing base line variations during microelectronic manufacturing, e.g., semiconductor processing. It would further be desirable to provide data for diagnosing base line variations within process tool groups during manufacturing. Additionally, it would also be desirable to provide a diagnostic which determines one or more causes of undesirable variations from a base line. It would also be desirable to detect tools and/or processing modules having performance varying or shifting from base line performance specifications which may result in yield or reliability degradation

### SUMMARY OF THE INVENTION

In an aspect of the invention a method for analyzing process module performance in semiconductor manufacturing includes: providing a plurality of process modules as part of at least one processing tool, the process modules including function specifications; initiating a process in the process module including steps, each step including performance parameters; detecting at least one predetermined measurement in the process module; generating data about the process module and the process steps; performing a statistical analysis of the process modules and the process steps using the generated data, and the performance parameters; determining variations in the data from the performance parameters of the steps and the function specifications of the process modules; computing process module mis-match statistics (PMMS); determining when a specified variation of PMMS occurs between the process modules function specifications and the step performance parameters; identifying and corresponding at least one process step and process module with the specified variation from the step performance parameters and the function specifications when the specified variation occurs; and presenting the specified variation with the corresponding process step and the process module having the specified variation.

In a related aspect, the PMMS computation uses multivariate data analysis. The step of generating data may include using historical data. The method may further include presenting data of the process steps with the specified variations from the performance parameters. The step of generating data may include collecting multi-variate metrics from a plurality of process modules running the same process. The tool may be part of a tool group, and the function specifications are for the tool group. The method may further include a plurality of process modules all of the same tool group. The method may also further include presenting process module data for each of the process steps. The plurality of processing tools may each include a plurality of process modules. The plurality of process modules may run the same processes. Each of the tool groups may include function specifications. The method ma further include: communicating the corresponding process step and process module to a process control device; determining a corrective action using the process control device; and modifying the process steps and the process module environment in the corresponding process module using the process control device. The data from the process module may include environmental data of an inner cavity of the process module.

In another aspect of the invention, a computer program product comprising a computer readable medium has recorded thereon a computer program for enabling a processor in a computer system to analyze process module performance in semiconductor manufacturing. A plurality of process modules are part of at least one processing tool and the process modules include function specifications. The computer program performs the steps of: initiating a process in the process module including steps, each step including performance parameters; detecting at least one predetermined measurement in the process module; generating data about the process module and the process steps; performing a statistical analysis of the process modules and the process steps using the generated data, and the performance parameters; determining variations in the data from the performance parameters of the steps and the function specifications of the process modules; computing process module mis-match statistics (PMMS); determining when a specified variation of PMMS occurs between the process modules function specifications and the step performance parameters; identifying and corresponding at least one process step and process module with the specified variation from the step performance parameters and the function specifications when the specified variation occurs; and presenting the specified variation with the corresponding process step and the process module having the specified variation.

In another aspect of the invention, a system for analyzing process module performance in semiconductor manufacturing includes a processing tool and a plurality of process modules as part of the processing tool. The process modules include function specifications, and the process modules run processes including steps wherein each step includes performance parameters. A detection device detects at least one predetermined measurement in the process module. A computing device uses a program stored on computer readable medium for generating data about the process module and the process steps. The computing device performs a statistical analysis of the process modules and the process steps using the generated data, and the performance parameters. The computing device determines variations in the data from the performance parameters of the steps and the function specifications of the process modules. The computing device computes process module mis-match statistics (PMMS) and determines when a specified variation of PMMS occurs between the process modules function specifications and the step performance parameters. The computing device identifies and corresponds at least one process step and process module with the specified variation from the step performance parameters and the function specifications when the specified variation occurs.

In a related aspect, the computing device presents the specified variation with the corresponding process step and the process module having the specified variation. The system may further include a second computing device communicating with the first computing device, the second computing device controlling the process modules and process steps. The second computing device may modifies the process steps in response to the statistical analysis from the first computing device.

### BRIEF DESCRIPTION OF THE DRAWING

These and other objects, features and advantages of the present invention will become apparent from the following detailed description of illustrative embodiments thereof, which is to be read in connection with the accompanying drawings, in which:

FIG. 1 is a block diagram of a system according to an embodiment of the invention depicting an process module, detection devices and a semiconductor wafer;

FIG. 2 is a block diagram depicting a method according to the embodiment of the invention; and

FIG. 3 is an illustrative flow chart of the method shown in FIG. 2.

### DETAILED DESCRIPTION OF THE INVENTION

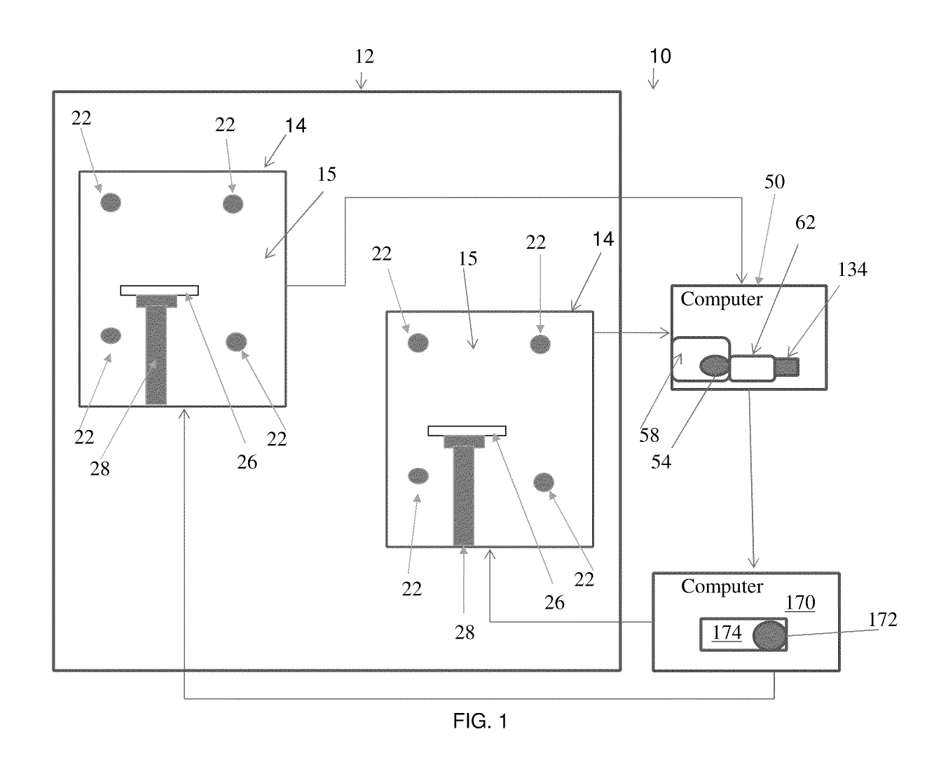

Referring to FIG. 1, an illustrative embodiment of a system or tool 10 employing a method according to the present invention is shown. The system or tool 10 provide for analyzing and measuring process module performance in semiconductor manufacturing. The system or tool 10 includes providing process modules 14 each having an inside cavity environment 15. The process modules 14 are part of the process tool 10. For illustrative purposes, the two process modules 14 are shown, however, many process modules may be used and multiple tools 10 may be used each having multiple process modules 14. Similar tools 10 are collectively referred to as tool groups. Such tool groups may have groups of like process modules 14. The process module 14 provides for processing of a semiconductor wafer 26 positioned in the process module 14 using a support 28. Mechanisms, such as robotic arms (not shown) may be used to move the wafers 26 in the process module 14 and to and from each of the process modules 14. Using the process module 14 may be part of many steps for manufacturing a semiconductor product. A microelectronic manufacturing process may include multiple process modules, and multiple tool groups. Each tool group may have performance specifications or parameters (e.g., baseline performance specifications). In the illustrative embodiment shown in FIG. 1, a process is initiated in the process module 14.

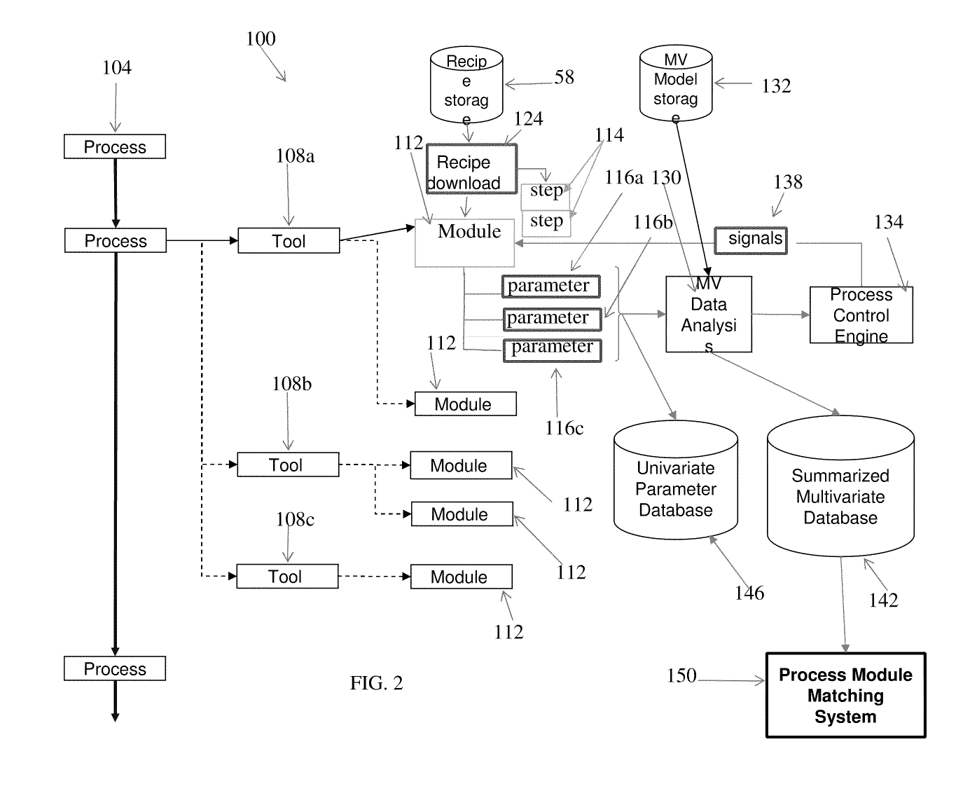

Referring to FIG. 2, the process includes a plurality of steps 114. The process modules 112 are part of a process 100 having tools 108, each having a series of steps 114. Each step includes specified performance parameters 116a-166c. For illustrative purposes the parameters are shown in FIG. 2 from one module 112, however, it is understood that all the modules 112 have specified parameters. One or more detection devices 22 provide for detecting one or more predetermined measurements in the process module 14 (FIG. 1).

Referring to FIGS. 1 and 2, the predetermined measurements include, for example, measurements in the process module environment 15, and the semiconductor wafer 26 during the process steps. For example, wafer and environmental measurements may include gas flows, temperatures, RF power, and implant energies. The process or method 100 according to the present invention, shown in FIG. 2, may include a plurality of processes 104a, 104b, 104c, each of the processes includes associated steps to arrive at a final semiconductor product. For example, one of the processes 104 includes associated tools 108a, 108b, 108c, wherein a further number of tools may be employed than shown in the embodiment herein (FIG. 2). The tools 108a-108c each include a plurality of process modules 112. Each module 112 includes a number of parameters, for illustrative purposes, three parameters are shown, a first parameter 116a, a second parameter 116b, and third parameter 116c. The module instructions may be downloaded 124 from the data storage 58 as shown in FIG. 2. The detection devices 22 quantify the predetermined measurements and generate data about the process module 14, including the inside environment 15 of the process module 14, and the process steps 114.

Referring to FIGS. 1 and 2, a statistical analysis of each of the process modules using the generated data is performed using a computer 50 communicating with the process module 14 and the detection devices 22. The computer includes a program 54 saved on a computer readable medium such as data storage 58 (for example, a database) and a processor 62 for analyzing and the data and providing the statistical analysis. The computer conducts a multivariate analysis 130 (FIG. 2) as one embodiment of the statistical analysis. The computer 50 may also communicate with other computers and a user monitoring the process. In the embodiment show in FIG. 1, the computer 50 communicates with another computer 170. The computer 170 monitors and controls the process 134 as shown in FIG. 2. The computer program 54 compares the performance parameters 116a-166c of each process step and the tool and process module function specifications with the predetermined measurements to determine variations from the process step performance parameters and the process module function specifications. A process control engine 134 is generated by the program 54 for monitoring the modules 112 shown in FIG. 2. The process control engine 134 sends signals 138 to the module 112, for illustrative purposes the signal 138 is shown being sent to one module 112, but it is also envisioned that the signal be sent to all the modules 112.

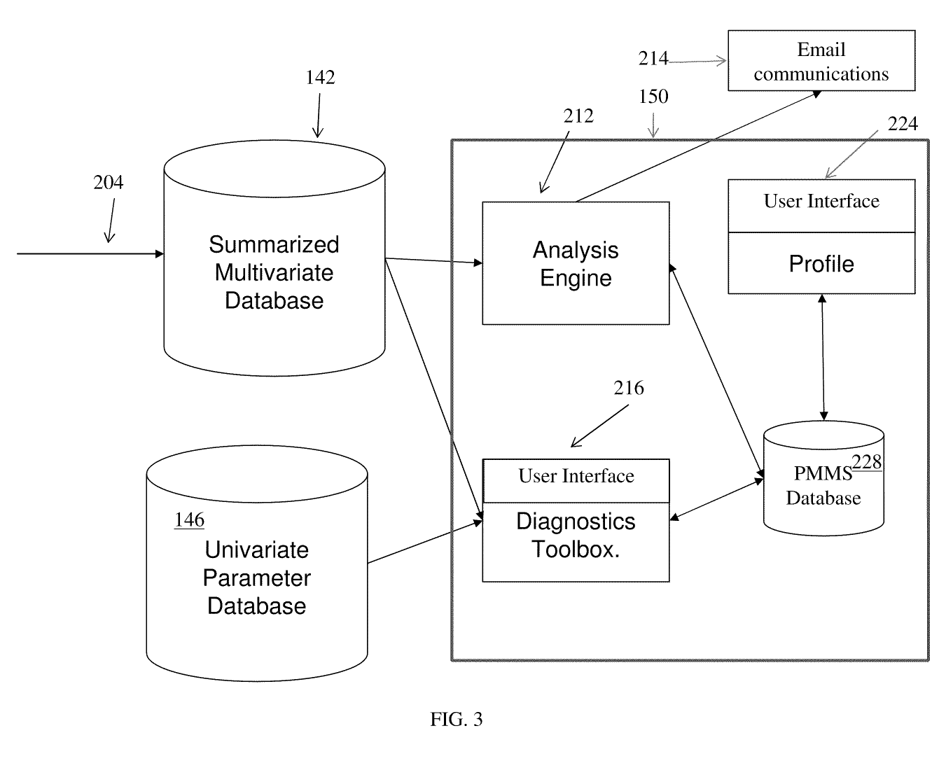

The program 54 of computer 50 performs a data analysis embodied as a multivariate analysis 130, shown in FIG. 2. The multivariate methodology may be, for example, a Hotellings T square (T²), Projection of principal component, Distance from Principal Component Model, as well as other multivariate analysis. The computer program 54 computes process module mis-match statistics such as process module matching statistics (PMMS) in step 142 shown in FIG. 2, and determines when a specified variation of PMMS statistics from the process steps specified performance parameters occurs in diagnostic step 150, using the computer 50 (FIG. 1) and the database 146 of stored data. The process module matching statistics (PMMS) are computed based on multivariate data, for example, wherein: PMMS=(Range of T²)/(Median of T²). The computer program 54 identifies and corresponds at least one process step with the specified variation from the process step specified performance parameters when the specified variation occurs in step 150. The computer program 54 thereby identifies the step(s) 114 of the process 104 and/or the malfunctioning process module 112 in one or more of the tools 104 associated with the variation in specified performance parameters. The computer program 54 may also present the results of the PMMS 154 (FIG. 2) to a user for further identification and analysis of process module steps which exceed performance parameter variations. The computer program 54 further provides diagnostic analysis 216 (FIG. 3) and solutions 220 (FIG. 3) as in step 154 (FIG. 2). The computer 50 of system 10 can also provide the computer 170 with the analysis of step 130 (FIG. 2) for changing, modifying, or shutting down the process in a particular process module 112.

Referring to FIG. 3, an illustrative flow chart 200 relating to the method of the present invention 100 (FIG. 2) includes processing the data from the detectors 22 (FIG. 1) in step 204. Step 208 stores historical data in the database 146 (shown in FIG. 2). In step 212 the program 54 (FIG. 1) processes the data and in step 216 provides diagnostics and possible solutions (as in step 150 shown in FIG. 2) for the malfunctioning indicated process module 112, or wafer 26 in the process module environment 15. The computer program 54, using the multivariate analysis 130 (FIG. 2), presents the results of the PMMS and diagnostic analysis 216 (FIG. 3) and solutions in step 220. The analysis and solutions may be presented using numerous interfaces, such as, charts or using drill down menus, colors, and light to designate the module, step in the process, malfunctioning tool or module environmental variation from specified parameters.

The method of the present invention may also collect data for a plurality of tools in a tool group and analyze the data for anomalies which indicate that one or more tools are performing poorly, e.g., outside of specification. Thereby, the present invention can use data from tool groups to better indicate when a tool is malfunctioning or performing below standards.

Referring to FIGS. 1-3, in operation, the method of the present invention employs the system described above for analyzing process module performance in semiconductor manufacturing. The method 100 includes providing the process module 14 and having the wafer 26 positioned inside 15 the process module 14. One or more processes 104 are initiated in the process module 14 for manufacturing the semiconductor wafer 26. The process 104 includes steps 114 using the process modules 112. Each step 114 includes specified performance parameters 116a-116c. The detectors 19 detect predetermined measurements in the process module 14. The method 100 analyzes data 130 about the processing tool 100, and generates data about the steps 114 and the process module 112. The data generation 150 includes using historical data 208 (FIG. 3) in the data base 146 (FIG. 2).

The method 100 performs the statistical analysis 130 (FIG. 2) of the process steps 114 using data from the detection devices 22 and the historical data from the database 146. The method 100 determines variations 150 from the process step performance parameters and the process module function specifications, and computes process module mis-match statistics (PMMS) 150 (FIG. 2) using multivariate data analysis. The method 100 determines when a specified variation occurs between the PMMS and the process module step specified performance parameters. The method 100 identifies and corresponds 154 process steps 114 with the specified variation from the process step specified performance parameters when the specified variation occurs. The method 100 presents the specified variation between the process step and the corresponding process step specified performance parameter in step 154.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for analyzing process module performance in semiconductor manufacturing, comprising:
providing a plurality of process modules as part of at least one processing tool, the process modules including function specifications;
initiating a process in the process module including steps, each step including performance parameters;
detecting at least one predetermined measurement in the process module;
generating data about the process module and the process steps;
performing a statistical analysis of the process modules and the process steps using the generated data, and the performance parameters;
determining variations in the data from the performance parameters of the steps and the function specifications of the process modules;
computing process module mis-match statistics (PMMS);
determining when a specified variation of PMMS occurs between the process modules function specifications and the step performance parameters;
identifying and corresponding at least one process step and process module with the specified variation from the step performance parameters and the function specifications when the specified variation occurs; and
presenting the specified variation with the corresponding process step and the process module having the specified variation.

2. The method of claim 1, wherein the PMMS computation uses multivariate data analysis.

3. The method of claim 1, wherein the step of generating data includes using historical data.

4. The method of claim 1, further including:
presenting data of the process steps with the specified variations from the performance parameters.

5. The method of claim 1, wherein the generating data step includes collecting multi-variate metrics from a plurality of process modules running the same process.

6. The method of claim 1, wherein the tool is part of a tool group, and the function specifications are for the tool group.

7. The method of claim 6, further including a plurality of process modules all of the same tool group.

8. The method of claim 6, further includes:
presenting process module data for each of the process steps.

9. The method of claim 8, wherein the plurality of processing tools each includes a plurality of process modules.

10. The method of claim 9, wherein the plurality of process modules run the same processes.

11. The method of claim 7, wherein each of the tool groups include function specifications.

12. The method of claim 1, further including:
communicating the corresponding process step and process module to a process control device;
determining a corrective action using the process control device; and
modifying the process steps and the process module environment in the corresponding process module using the process control device.

13. The method of claim 1, wherein the data from the process module includes environmental data of an inner cavity of the process module.

14. A computer program product comprising a computer readable medium having recorded thereon a computer program for enabling a processor in a computer system to analyze process module performance in semiconductor manufacturing, wherein a plurality of process modules are part of at least one processing tool and the process modules include function specifications, the computer program performing the steps of:
initiating a process in the process module including steps, each step including performance parameters;
detecting at least one predetermined measurement in the process module;
generating data about the process module and the process steps;
performing a statistical analysis of the process modules and the process steps using the generated data, and the performance parameters;
determining variations in the data from the performance parameters of the steps and the function specifications of the process modules;
computing process module mis-match statistics (PMMS);
determining when a specified variation of PMMS occurs between the process modules function specifications and the step performance parameters;
identifying and corresponding at least one process step and process module with the specified variation from the step performance parameters and the function specifications when the specified variation occurs; and
presenting the specified variation with the corresponding process step and the process module having the specified variation.

15. A system for analyzing process module performance in semiconductor manufacturing, comprising:
a processing tool;
a plurality of process modules as part of the processing tool, the process modules including function specifications, the process module running a process including steps wherein each step includes performance parameters;
a detection device detecting at least one predetermined measurement in the process module;
a computing device using a program stored on computer readable medium for generating data about the process module and the process steps, the computing device performing a statistical analysis of the process modules and the process steps using the generated data, and the performance parameters, the computing device determining variations in the data from the performance parameters of the steps and the function specifications of the process modules, and the computing device computing process module mis-match statistics (PMMS) and determining when a specified variation of PMMS occurs between the process modules function specifications and the step performance parameters, the computing device identifying and corresponding at least one process step and process module with the specified variation from the step performance parameters and the function specifications when the specified variation occurs.

16. The system of claim 15, wherein the computing device presents the specified variation with the corresponding process step and the process module having the specified variation.

17. The system of claim 15, further including:
a second computing device communicating with the first computing device, the second computing device controlling the process modules and process steps.

18. The system of claim 17, wherein the second computing device modifies the process steps in response to the statistical analysis from the first computing device.
